(19) United States
(12) Patent Application Publication
(10) Pub. No.: US 2026/0371214 A1
(43) Pub. Date: Nov. 19, 2026

(54) WIRELESS MULTICHANNEL AUDIO SYSTEM WITH INCREASED RELIABILITY

(71) Applicant: Sennheiser electronic SE & Co. KG, Wedemark (DE)

(72) Inventors: Sebastian Georgi, Langenhagen (DE); Jan Watermann, Hannover (DE); Steffen Matthias, Hannover (DE); Florian Wilmshoever, Essen (DE)

(21) Appl. No.: 19/475,735

(22) PCT Filed: Jan. 7, 2025
(86) PCT No.: PCT/EP2025/050217

§ 371 Date: Oct. 15, 2025

(30) Foreign Application Priority Data
Jan. 9, 2024 (DE) 10 2024 100 484.3

(51) Int. Cl. H04W 36/36; H04W 12/033; H04W 72/0446; H04W 76/15

(52) U.S. Cl. CPC H04W 36/362; H04W 12/033; H04W 72/0446; H04W 76/15

(57) ABSTRACT

A wireless multi-channel audio system (101) is proposed, comprising a production base station (400) connected to an antenna (200), and comprising a plurality of mobile devices. The production base station and the mobile devices are adapted to exchange audio data with one another using a multiplexing method. The production base station provides an RF channel on which the production base station (400) and the mobile devices send and receive audio data. The production base station and the mobile devices connected to one another in the audio system mutually exchange unique device identifiers so that data exchange is only possible between devices whose device identifier is mutually known. Settings and data of the audio system are stored in the production base station as production data. A replacement base station (401) is communicatively connected to the production base station during the transmission of the production data. The production data of the production base station are stored in the replacement base station (401), wherein the replacement base station (401) does not transmit or receive audio data as long as the production base station (400) is functioning.

### FIELD

The present invention relates to a wireless multi-channel audio system with increased reliability.

### BACKGROUND

Wireless multichannel audio systems are known from the ETSI EN 300422 standard as Wireless Multichannel Audio Systems (WMAS). This type of audio system is a wireless audio system in which multiple channels are used for audio transmission. In this case, multiple wireless transmitters (e.g., wireless microphones) and multiple wireless receivers (e.g., in-ear monitoring units) can communicate simultaneously with a base station. If the base station fails, the entire audio system is no longer functional.

Starting from this, it is the object of the present invention to provide an audio system with increased reliability, in which the failure of a single component, in particular the base station, does not result in the entire audio system no longer being functional.

In the priority-substantiating German patent application, the German Patent and Trademark Office searched the following document: CN 101426247 A.

### DESCRIPTION OF THE INVENTION

In order to achieve this object, the invention proposes, according to a first aspect, a wireless multi-channel audio system comprising a production base station connected to an antenna and a plurality of mobile devices. The production base station and the mobile devices are adapted to exchange audio data with each other using a multiplexing method. The production base station provides an RF channel on which the production base station and the mobile devices send and receive audio data. Unique device identifiers of the mobile devices connected to the production base station in the audio system are stored in the production base station. A unique device identifier of the production base station is stored in the mobile devices connected to the production base station in the audio system, so that data exchange is only possible between devices whose device identifier is mutually known. Data exchange between known devices takes place in encrypted form. All settings and data of the audio system are stored in the production base station as production data, including the keys used. All production data of the production base station is stored in the replacement base station. As long as the production base station is functioning normally, the replacement base station does not send or receive audio data, in particular, the replacement base station does not send or receive audio data to or from the mobile devices.

The proposed multi-channel audio system ensures that even if the production base station fails, a production just produced is not completely aborted, but at best temporarily interrupted and can be continued by means of the replacement base station. For large and important events, this is a significant advantage and much less costly than maintaining two complete and redundant audio systems, which in many cases would not be feasible for practical and/or economic reasons anyway.

A replacement base station is communicatively connected to the production base station at least during the transmission of production data. Once the production data is stored in the replacement base station, communication between the production and replacement base stations is no longer necessary.

In an advantageous exemplary embodiment, the production base station and the mobile devices are adapted to exchange data with each other using a TDMA method. The TDMA method is a reliable and proven method for transmitting multiple audio channels over a single RF channel.

In a preferred exemplary embodiment, an audio link is provided between the production base station and each connected mobile device, after which audio transmission takes place on the basis of repeating frames divided into a number of time slots, and each connected mobile device sends or receives audio data in at least one specified time slot of the frame. The specified time slot(s) are stored as production data in the production base station. The production data contains all the necessary settings to adapt the replacement base station so that the replacement base station can take over the function of a failed production base station at the push of a button. Time-consuming settings are therefore not necessary in the event of a failure.

Advantageously, the carrier frequency, the modulation method, synchronization data, and/or the bandwidth of the RF channel is or are stored as production data in the production base station. This data is also expediently stored in the replacement base station.

In the event of a failure of the production base station or if the audio system receives a switchover command, the replacement base station takes over the function of the production base station. The increased reliability of the audio system is of great importance to users, in particular for expensive or productions that are important for other reasons.

In a preferred exemplary embodiment, the replacement base station takes over the unique identifier of the production base station. In this way it is ensured that data exchange between the mobile devices and the replacement base station takes place without interruption since the respective unique device identifiers are then mutually known.

Advantageously the production base station does not send and/or receive any audio data whilst the replacement base station functions as the production base station and sends audio data to the mobile devices and receives audio data from the mobile devices. This ensures that only one base station is active in the audio system at any one time.

Since the audio transmission is encrypted, the key exchanged during establishment of the connection is crucial for communication. A replacement base station can accordingly only be activated if it also has the key. A simple copy of the configuration is therefore not sufficient. On the other hand, the key must be secured with the necessary care to prevent unauthorized eavesdropping.

In a further development of the invention, the production data in the replacement base station cannot be changed. In this way it is achieved that a user does not create multiple replacement base stations and use them in different productions. This approach would undermine efforts to ensure data security during audio transmission between the mobile devices and the respective base station, because all the replacement base stations would use the same key to encrypt the data transmission.

In this exemplary embodiment, it is expediently provided that the replacement base station can be reset to its factory state by a command, and then all the configuration and command parameters can be adjusted again. After the replacement base station has been reset to its factory state, it can be used again as a production base station with full functionality, just like any other base station, since at the hardware level, there are no differences between a production base station and a replacement base station.

In an advantageous exemplary embodiment, the production and replacement base stations are connected to a network router or switch that establishes wired connections either to the production base station or to the replacement base station as desired. This exemplary embodiment has the advantage that an operator does not need to perform any manual intervention to switch from a failed production base station to a replacement base station during production.

In a further development of the invention, the wired connections are network connections.

In a preferred embodiment of the invention, the production base station is connected to a control console that receives input commands from an operator to modify production data. The control console provides an ergonomic user interface for operating the audio system. The control console is, for example, a control computer connected to the production base station.

In a method not pertaining to the invention for operating an audio system according to the first aspect of the invention, the replacement base station receives data from mobile devices and production data from the production base station during normal operation, when the production base station is functioning normally, but does not transmit any data. In the event of a malfunction, when the production base station no longer functions correctly, the replacement base station is activated by a switchover command and takes over all functions of the production base station. The advantages already described in connection with the audio system according to the first aspect of the invention are achieved with this method.

According to a second aspect, the invention proposes a method for operating an audio system according to the first aspect of the invention. During normal operation, when the production base station is functioning normally, the replacement base station is switched off. In the event of a malfunction, when the production base station is no longer functioning correctly, the production base station is switched off and the replacement base station is switched on and takes over all the functions of the production base station.

If multiple base stations are used in a production, the settings of all base stations can be loaded into the replacement base station. If an error occurs in one of the active base stations, its configuration can be selected on the replacement base station.

In a further development of the method, in the event of a malfunction, a user interface of the control console is completely or partially locked to prevent changes to the production data. In this way, it is ensured that multiple productions cannot be made in parallel using identical production data, in particular not using identical keys for encoding the audio data.

Alternatively, it can also be provided that in the event of a malfunction, the replacement base station does not allow changes to the already stored production data. In this way it is also achieved that multiple identical replacement base stations are not used for different productions.

### BRIEF DESCRIPTION OF THE FIGURES

The invention will be explained in more detail below using an exemplary embodiment with reference to the accompanying figures. All figures are purely schematic and not to scale. In the figures:

FIG. 1 shows a schematic diagram of a wireless multi-channel audio system;

FIG. 2 shows a schematic representation of time slots of various wireless transmitters;

FIG. 3 shows a schematic representation of a frame during the transmission of audio data;

FIG. 4 shows a first exemplary embodiment of an audio system according to the invention without mobile devices;

FIG. 5 shows a second exemplary embodiment of an audio system according to the invention without mobile devices; and

FIG. 6 shows a third exemplary embodiment with two base stations of an audio system according to the invention without mobile devices.

Identical or similar elements are provided with identical or similar reference numerals in the figures.

### DESCRIPTION OF AN EXEMPLARY EMBODIMENT

Wireless multi-channel audio systems (WMAS) are known from the ETSI EN 300422 standard. In this case, multiple mobile devices, such as multiple microphones or multiple in-ear monitoring units, can be used simultaneously with a base station.

If multiple audio transmitters (e.g., a handheld microphone or other microphones) simultaneously transmit audio signals to a base station, and the base station transmits a second audio signal composed of these audio signals to an in-ear monitoring unit or a beltpack, the microphones do not transmit simultaneously but subscriber access is achieved using a Time Division Multiple Access (TDMA) method with a repeating frame comprising a number of time slots per RF channel. For example, 128 time slots per frame can be provided for the transmission of audio streams. Additional time slots can be provided for control data. Thus, up to 128 mobile devices can communicate with the base station.

The TDMA method ensures multiple access to a wireless audio transmission through a temporal sequence of multiple participants. The minimum latency is determined by the largest distance between two consecutive time slots.

FIG. 1 shows a schematic representation of a wireless multi-channel audio system. The wireless multi-channel audio system WMAS 100 is based on the ETSI EN 300422 standard and comprises a base station 400, at least one antenna 200, and a plurality of mobile devices 300, e.g., at least one handheld microphone (mobile transmitter) 310, optionally at least one multi-channel microphone (mobile transmitter) 320, optionally a first beltpack (mobile receiver) 330, 340 with an output for in-ear monitoring, optionally a combined second beltpack (mobile receiver) 350 with an input for microphone signals and an output for in-ear monitoring. Thus, the number of mobile transmitters 310, 320 or mobile receivers 330, 340, 350 in the wireless multi-channel audio system 100 can vary.

In the wireless multi-channel audio system 100, the base station 400 is connected to an antenna 200 via a cable 202 and provides an RF channel. Optionally, additional antennae can be connected to the base station 400, which can provide additional RF channels. The antenna 200 can have an RF transmitter (“radiohead”), so that digital signals are transmitted via the cable 202, which are converted into analog RF signals in the radiohead.

A control console 500 connected to the base station 400 can provide a user interface by means of which an operator can enter configuration and control commands for the base station 400. The control console 500 is, for example, a computer on which a software program for controlling the base station 400 is executed. The configuration and control commands, as well as the associated parameters, are stored in the base station 400 in a non-volatile memory as production data. Optionally, the base station 400 can be coupled to a mixer 600. By means of the mixer 600, the audio signals from the respective wireless audio transmitters (e.g., microphones) can be mixed into an overall audio signal. In one exemplary embodiment of the invention, configuration and control commands are transmitted directly from the mixer 600 to the base station 400.

The wireless multi-channel audio system 100 can, for example, have a number of microphones, namely a handheld microphone 310, a multi-channel or stereo microphone 320, and mobile receiving devices 330, 340, 350. The mobile receiving devices 330-350 can have an output for a so-called in-ear monitoring, which allows a wearer to receive an audio channel. The mobile receiving device 350 is additionally equipped with a microphone input for a clip-on microphone or lavalier microphone. The user of the mobile receiving device 350 is thus able to simultaneously receive one audio channel and transmit another audio channel. The microphones 310, 320 and mobile receiving devices 330-350 are collectively referred to below as mobile devices. In other applications, more or fewer mobile devices than those shown in FIG. 1 can be integrated into the wireless multi-channel audio system 100.

The microphone 310 sends first audio data 311 in the form of an audio stream to the base station 400. The second microphone 320 sends second audio data 321 in the form of an audio stream to the base station 400. Finally, the mobile device 350 (beltpack) sends third audio data 351 in the form of an audio stream via the antenna 200 to the base station 400. The mobile devices 330 and 340 receive audio data 331, 341, 351 in the form of an audio stream from the base station 400.

The base unit 400 transmits control data 201 via the antenna 200 to the respective mobile devices, e.g., transmitter/receivers 310, 320, 330, 340, 350. The control data 201 is used by the mobile devices 310-350 to set wireless transmission parameters. Using the control data 201, the base station 400 can specify transmission parameters for the mobile devices 300, such as a transmission frequency, a time slot in the transmission frame, a transmission power, etc. These transmission parameters belong to the previously mentioned production data. The base station 400 can control the transmission from the mobile devices to the base station 400 and from the base station 400 to the mobile devices 300 by means of the production parameters.

The control data 201 includes control and/or status information that is exchanged between the mobile devices and the base station. In addition to the control information or control data, further data can be exchanged as part of the control data 201.

For example, in a case with 128 TDMA time slots per frame, one time slot can be reserved after every 16 time slots. This time slot can be used for control data such as synchronization information and control and status signals.

Optionally, a frame can therefore have 128 TDMA time slots for audio transmission and 8 time slots for control signals, so that a frame has, for example, 136 time slots.

Alternatively, the control data can also be transmitted in those time slots that are not reserved and therefore free. In this case, no separate time slots are provided for the transmission of the control data; instead, the control data is transmitted depending on the presence of time slots not used for audio transmission.

For example, communication from the base station 400 to the mobile devices 330, 340, 350 takes place in a multicast and communication from the mobile devices 310, 320 to the base station 10 takes place in a unicast.

The control console 500 is connected to the base station 400 and has a user interface (UI) that enables the user to enter configuration and/or control commands for the base station 400.

The handheld microphone 310 transmits audio data as first audio data 311 in the form of an audio stream wirelessly as a unidirectional radio transmission to the base station 400. This transmission 311 takes place, for example, in a unicast. The audio transmission can be in the form of mono-microphone data.

The microphone 320 transmits audio signals 321 as an audio stream in the form of a unidirectional radio transmission. Stereo or multi-channel microphone data can be transmitted in a unicast. The first and/or second beltpacks 330, 340 (mobile receiving units) receive audio data 331, 341, all in a unidirectional radio transmission, from the base station 400. This radio transmission can comprise, for example, in-ear monitoring data. In a practical application, the audio data 331, 341 are composed of the audio data 321, 311 from the two microphones 310, 320, as well as optionally additional audio data. This data can be transmitted as a unicast or multicast from the base station 400. The beltpack 350 (receiving unit) can communicate with the base unit 400 in the form of a bidirectional radio transmission 351. The microphone data which the beltpack has received via the microphone input is transmitted to the base station 400 as a unicast, for example. In-ear monitoring data is transmitted from the base station 400 as a unicast or multicast.

In one exemplary embodiment, the audio data from the respective audio data transmitters (microphones 310, 320) is transmitted using a TDMA method. The TDMA method ensures multiple access to a wireless audio transmission through a temporal sequence of multiple subscribers. For a transmission with low latency, for example, a deterministic and equidistant grid of time slots per audio channel can be used. The minimum latency is determined by the largest distance between two consecutive time slots.

If a multi-channel audio system is to be provided, where more than two audio channels are to be transmitted from the base station to the mobile receivers, the transmittable audio samples in a frame must be divided among the available audio channels. If three audio channels are to be transmitted, for example, the possible number of samples that can be transmitted in a frame can be divided by the three audio channels, i.e., audio samples of the available audio channels are transmitted in each frame.

Thus, each of the audio channels only controls a fraction of the audio samples in a frame or time slot. The transmission of audio samples per channel per frame is thus reduced but this is offset by the reduced frame latency between consecutively transmitted frames.

The wireless multi-channel audio system 100 can have a channel bandwidth of 6 MHz, 8 MHz, or 10 MHz. Transmission takes place, for example, in the frequency ranges 470-698 MHz (UHF) and 1350-1525 MHz (1G4).

Access of subscribers to the transmission channels takes place using the Time Division Multiple Access (TDMA) method. Optionally, the number of subscribers can be up to, for example, 128 independent audio channels per broadband channel. The modulation method can be Orthogonal Frequency Division Multiplexing OFDM in combination with various subcarrier modulation or coding methods. The audio coding can be carried out using various methods and sampling rates, as well as in mixed mode. For example, the sampling rates can be 48 kHz or 96 kHz. The audio coding can be carried out using the OPUS method, the ADPCM method, the PCM method, or another suitable coding method. Synchronization of the TDMA grid and the carrier offset estimation CFO estimation can be ensured by means of synchronization patterns. A basic TDMA grid is ≤10 ms and can be divided into ½, ¼, ⅛, or 1/16 sub-grids.

The audio transmission is preferably encrypted. The base station 400 provides a synchronization signal, manages connected or “paired” devices (explanations below), and allocates the corresponding communication resources. The base station 400 can generate audio signals from the received audio signals from the wireless transmitters, which can represent a mixture of the audio signals from the wireless transmitters. These audio signals can then represent an in-ear monitoring audio signal.

The mobile devices 300, 310-350 can register with the base station 400 to enable communication with the base station 400. The mobile devices 310-350 can optionally initiate a transmission of audio data if they have previously detected a base station 400 with which they should communicate.

For this purpose, the mobile devices must be “paired” with the base station. The pairing can take place in several steps. Firstly, the operator decides at which frequency the base station provides the RF channel. Optionally, the base station is adapted to identify other transmitters in the permitted frequency band, so that the operator can select the frequency for the RF channel so that as far as possible there is no interference from other transmitters. The base station transmits a control slot within a frame on the RF channel. The control slot contains a unique ID (unique identification) for the base station. After the pairing process has been initiated on the mobile devices on the respective mobile device, for example by pressing a button, the mobile device searches for an RF signal, finds the RF channel of the base station, and reads out the control slot. The mobile device then sends its own unique ID to the base station in another control slot and is displayed as a device ready for pairing. The base station operator confirms the mobile device has been found, and the base station saves the unique ID of the mobile device The mobile device receives confirmation from the base station in the next control slot and, in turn, saves the unique ID of the base station.

Optionally, the pairing can be completed by the operator of the base station whereby the user verifies a PIN code of the mobile device. Only after pairing are the mobile devices ready to transmit a signal. Typically, the pairing of the mobile devices with the base station before a production is performed by a sound engineer in such a way that all mobile devices are physically present for him and it is thus impossible for third parties to “sneak” a mobile device into the audio system in order, for example, to eavesdrop without authorization. Furthermore, it is not possible for the base station to process signals from unpaired devices.

For each of the TDMA resources (i.e., for each stream) in the audio transmission system, it can be specified by means of which RF modulation the wireless transmission takes place. Examples of RF modulation are Q-PSK or QAM 64. Whereas Q-PSK modulation allows for greater robustness against interference and greater directionality, QAM 64 modulation enables higher data rates. The total available data rate for a stream is then obtained from the RF modulation used and the number of available time slots in a frame.

The audio data transmitted in a stream can be transmitted uncompressed or compressed. The required data rate for an uncompressed transmission of an audio channel is obtained from the product of the sample rate (e.g., 48 kHz, 96 kHz) and the resolution (e.g., 16 bits). Audio codecs can be used to reduce the data rate. An audio codec can be adjusted by means of parameters so that the audio quality is increased at the expense of data rate, or conversely, the data rate is reduced at the expense of audio quality. The parameters for the audio encoding and decoding are also stored as production parameters in the base station 400.

To meet data protection requirements, communication between the mobile devices and the base station can be encrypted with a symmetric key. The key exchange between the base station and the mobile devices is carried out using a public/private key method.

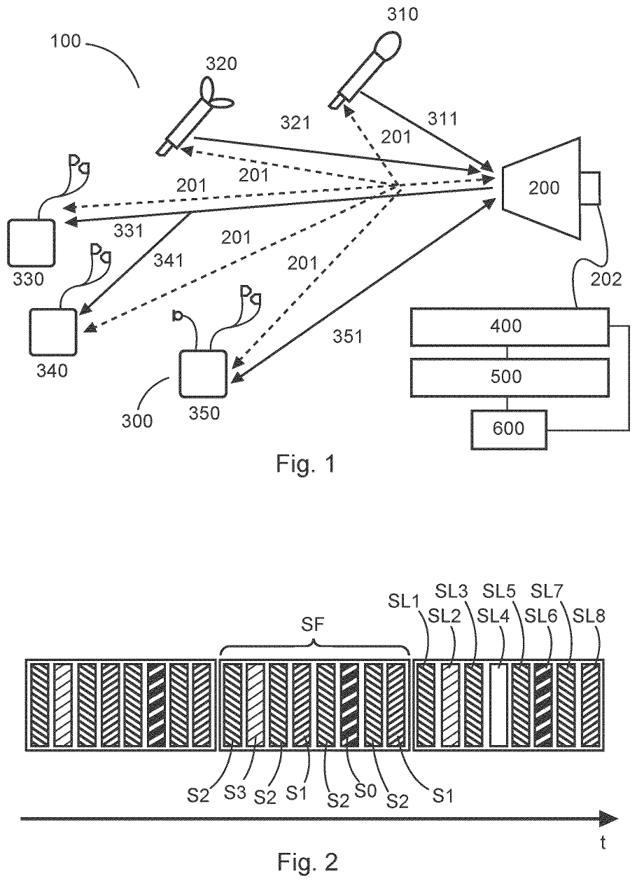

FIG. 2 shows a representation of time slots of various wireless transmitters received by the wireless receiver. In the TDMA method, the respective audio transmitters are assigned a time slot within a frame. In FIG. 2, eight time slots SL1-SL8 are provided per frame SF. However, this is only an example for illustration purposes. Thus, eight time slots SL1-SL8 can be transmitted per frame. The time slots SL1-SL8 are repeated in each frame SF.

In this example, there are three streams S1, S2, and S3. Each stream is assigned a wireless audio transmitter. Furthermore, time slots S0 which are not used may be present in the frame SF. In the example shown in FIG. 2, the first stream S1 requires 2/8 of the resources, stream S2 requires 4/8, and stream S3 requires ⅛.

The first stream S1 occupies the time slots SL4 and SL8. The first, third, fifth, and seventh time slots SL1, SL3, SL5, and SL7 are occupied by the second stream S2. The third stream S3 occupies the time slot SL2. The sixth time slot SL6 is unused.

When transmitting audio data of the respective wireless audio transmitters, it is important that the latency of the respective audio transmission is as low as possible.

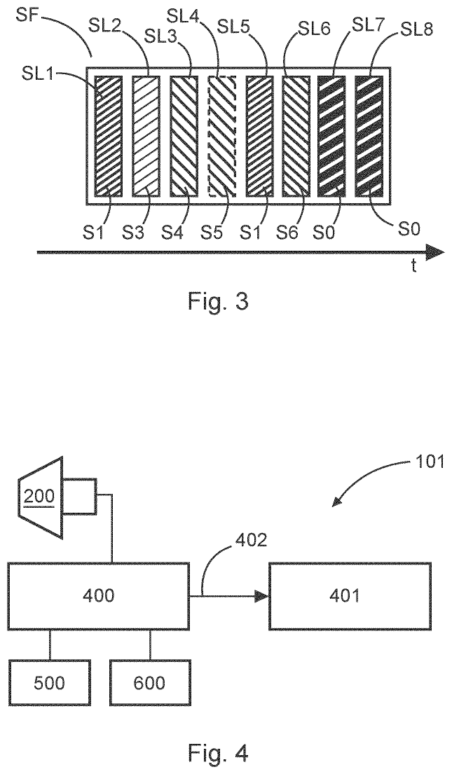

FIG. 3 shows a schematic representation of a frame during the transmission of audio data. In particular, FIG. 3 shows a frame SF with eight time slots SL1-SL8. In this case, two time slots SL7, SL8 are not required for the transmission of the audio data. These time slots are therefore free time slots S0. In this example, a first stream S1 uses 2/8 of the resources and four further streams S2-S5 each use ⅛ of the resources. Since two time slots S0 are not used, another stream requiring 2/8 of the resources could be included in the frame SF. However, if this stream is inserted at the point where the two unused time slots SL7, SL8 are provided, this can lead to a deterioration in the latency of the new stream.

From the perspective of the users of the audio system 100, it is necessary to ensure a high reliability for highly important productions. A total production failure, as a worst-case scenario, must be avoided at all costs from the viewpoint of the users. In order to avoid a single point of failure, an obvious and always possible solution is to set up the system twice—with different frequencies, power supplies, building components, etc. However, this is not cost-effective in practical applications.

Possible malfunctions include radio interference, power outages, broken cables, defective control consoles or control computers, defective microphones, and defective base stations. A base station by means of which an audio production is made is referred to hereinafter as a production base station. The present invention specifically addresses the problem of the production base station unexpectedly failing during an ongoing production. In this case, a replacement base station is available, in which all the production data of the production base station is already stored.

FIG. 4 schematically illustrates an audio system 101 according to the invention, omitting the mobile devices. In contrast to the audio system 100 illustrated in FIG. 1, in the audio system 101, a replacement base station 401 is connected to the production base station 400 via a communications link 402. In the interest of the greatest possible data security, the communications link 402 is preferably a wired connection. In principle, in other exemplary embodiments, it is also possible to provide a correspondingly secured wireless connection 402 between the production base station 400 and the replacement base station 401. The production data and any changes thereto are transmitted from the production base station to the replacement base station 401 via the connection 402, so that all the production data that was set at the production base station before a production is also stored in the replacement base station. The replacement base station 401 is synchronized with the production base station 400 and with the mobile devices 310-350. The replacement base station 401 takes over the unique identification (unique ID) of the production base station 400, but remains “silent” during normal operation as long as the production base station 400 is functioning correctly, i.e., does not fail completely or partially. Specifically, the replacement base station 401 does not send any signals to the mobile devices and also does not output any signals to its wired outputs. Only when a problem occurs at the production base station 400 and the operator decides to switch to the replacement base station, then in one exemplary embodiment a single command from the operator is sufficient for the replacement base station 401 to take over the role of the production base station 400. In this case, the production base station 400 is switched off, in particular, the production base station 400 no longer sends or receives any audio signals from the mobile devices, and the replacement base station 401 takes over all tasks which were previously performed by the production base station 400.

According to another exemplary embodiment, the replacement base station is switched off during normal operation of the audio system 101. If the production base station 400 fails, the operator turns off the production base station 400 and ideally disconnects it from the power supply. All connecting cables are then plugged into the replacement base station 401 as was the case with the failed production base station 400. The operator then starts the replacement base station 401 to continue production with the replacement base station 401.

By completely transferring the production data from the production base station 400, the base station 401 is already configured at the moment of switchover or switch-on so that it can take over all the connections of the production base station 400. This means that the operator must have copied the entire configuration of the production base station 400 to a replacement base station 401 before the event or production. The production data can, for example, be saved as a production file and copied as a file that is ideally encrypted with a public/private key pair. In an alternative exemplary embodiment, the production data is transferred in the background by the control software of the control console 500. The replacement base station 401 receives the keys for the encryption and all pairing information along with the production data. In order to fully restore the functionality of the audio system 101, it is then only necessary for the operator to switch wired connections from the production base station 400 to the replacement base station 401.

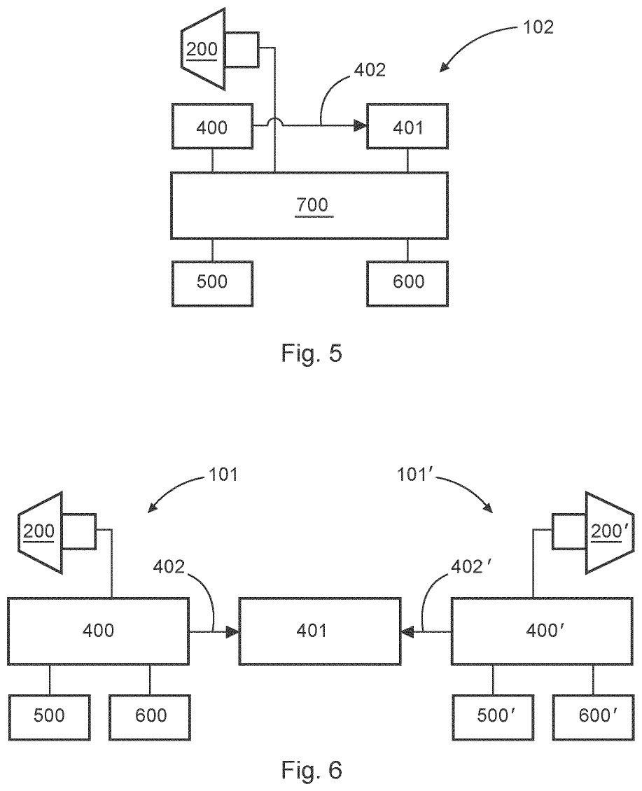

FIG. 5 shows another exemplary embodiment of an audio system 102 according to the invention. In the audio system 102, the production base station 400, the replacement base station 401, the control console 500, the mixer 600, and the antenna 200 are connected to a switch RX. During normal operation, when the production base station 400 is functioning correctly, the switch 700 makes the data connections between the production base station 400, the control console 500, the mixer 600 and the antenna 200. In the event of a malfunction, if the production base station 400 fails completely or partially and the operator decides to switch to the replacement base station 401 to continue production, then a corresponding command from the operator not only activates the replacement base station 401, but also switches the switch 700 so that the replacement base station 401 is connected to the control console 500, the mixer 600, and the antenna 200 instead of the production base station 400. In the audio system 102, no manual interventions by the operator are necessary to switch from the production base station 400 to the replacement base station 401, for example, to change wired connections.

FIG. 6 illustrates an extension of the audio system 101 from FIG. 4. Another audio system 101′ is connected to the replacement base station 401 via a connection 402′, this audio system comprising a production base station 400′, a control console 500′, a mixing console 600′ and an antenna 200′. The audio systems 101 and 101′ are used, for example, for different productions on two different stages in a theatre or other venue. The production data from both the production base station 400 and the production base station 400′ are stored in the replacement base station 401. This enables the replacement base station 401 to replace the production base station 400 and the production base station 400′ if necessary, by the operator making a corresponding selection. The specific further procedure of the operator for replacing one of the two production base stations is identical to the procedure described in connection with FIG. 4. The concept described with reference to FIG. 6 can be applied to cases where more than two production base stations are connected to a replacement base station.

In a further exemplary embodiment, after switching to the replacement base station, its configuration can no longer be changed in order to make continued use after a disaster unattractive. This is intended to prevent a situation where a large number of cloned base stations are created “in reserve” to a certain extent which are used in different productions, since all the base stations thus have the same encryption key. This would compromise data security. Once a base station has been cloned, it can be reused in a production with full functionality if a reset is carried out and configuration parameters are retransmitted from a control computer. In this case, a newly generated individual key for the respective base station would be used to encrypt the data.

1-18. (canceled)

19. Wireless multi-channel audio system (100-102) comprising
a production base station (400) connected to an antenna (200) and a plurality of mobile devices (310-350), wherein the production base station (400) and the mobile devices are adapted to ex-change audio data with each other in a multiplexing process, wherein the production base station provides an RF channel on which the production base station and the mobile devices (310-350) transmit and receive audio data, and
characterized by a replacement base station (401) which is configured to take over operation of the production base station if the production base station fails,
wherein unique device identifiers of the mobile devices (310-350) connected to the production base station in the audio system are stored in the production base station (400),
wherein a unique device identifier of the production base station is stored in the mobile devices (310-350) connected to the production base station in the audio system, so that data exchange is only possible between devices whose device identifier is mutually known,
wherein settings and data of the audio system (100-102) are stored as production data in the production base station (400),
wherein the production data of the production base station (400) are also stored in the replacement base station (401), and
wherein the replacement base station (401) does not transmit or receive any audio data as long as the production base station (400) is functioning,
wherein in the event of a failure of the production base station (400) or when the audio system receives a changeover command, the replacement base station (401) takes over the function of the production base station.

20. Audio system according to claim 19, characterized in that the unique identification of the production base station is also stored as production data in the production base station (400).

21. Audio system according to claim 19, characterized in that the replacement base station (401) is communicatively connected to the production base station at least during transmission of the production data.

22. Audio system according to claim 19, characterized in that the production base station (400) and the mobile devices (310-350) are adapted to exchange data with each other using a TDMA method.

23. Audio system according to claim 19, characterized in that an audio link is provided between the production base station (400) and each connected mobile device (310-350), according to which audio transmission takes place on the basis of repeating frames (SF) which are divided into a number of time slots (SL) and each connected mobile device (310-350) sends or receives audio data in at least one specified time slot of the frame (SF), and that the specified time slot(s) are stored as production data in the production base station.

24. Audio system according to claim 19, characterized in that the carrier frequency, the modulation method, synchronization data and/or the bandwidth of the RF channel is/are stored as production data in the production base station (400).

25. Audio system according to claim 19, characterized in that the replacement base station (401) takes over the unique identification of the production base station (400).

26. Audio system according to claim 25, characterized in that the production base station (400) does not transmit and/or receive any audio data as long as the replacement base station (401) has the function of the production base station and transmits audio data to the mobile devices or receives audio data from the mobile devices.

27. Audio system according to claim 19, characterized in that the production data in the replacement base station (401) cannot be changed.

28. Audio system according to claim 26, characterized in that the replacement base station (401) can be reset to a factory state by a command and then all the configuration and command parameters can be set again.

29. Audio system according to claim 19, characterized in that the production and replacement base stations are connected to a switch (700) which establishes wired connections as desired either with the production base station (400) or with the replacement base station (401).

30. Audio system according to claim 19, characterized in that the production base station is connected to a control console (500) which receives input commands from an operator to change production data.

31. Audio system according to claim 19, characterized in that the data exchange between the production base station and the mobile devices or between the replacement base station and the mobile devices is encrypted.

32. Method for operating an audio system according to claim 19, wherein in normal operation, when the production base station (400) is functioning normally, the replacement base station (401) is switched off, wherein the method is characterized in that
in the event of a fault, if the production base station (400) no longer functions correctly, switching off the production base station (400) and switching on the replacement base station (401) to take over all the functions of the production base station (400).

33. Method according to claim 32, characterized in that the production base station is connected to a control console (500) which receives input commands from an operator to change production data and characterized in that in the event of a fault, completely or partially blocking a user interface of the control console (500) in order to prevent changes to the production data.

34. Method according to claim 32, characterized in that encrypting the data exchange between the production base station and the mobile devices or between the replacement base station and the mobile devices.
